(19) United States
(12) Patent Application Publication
(10) Pub. No.: US 2026/0275701 A1
(43) Pub. Date: Sep. 17, 2026

(54) DRYWALL GRID SOFFIT FRAMING SYSTEM

(71) Applicant: USG INTERIORS, LLC, Chicago, IL (US)

(72) Inventors: Peder John Gulbrandsen, Aurora, IL (US); Steven James Bell, Olmsted Falls, OH (US); Michael Conner DeNicolo, Bartlett, IL (US); Michael Anthony Delgado, Chicago, IL (US)

(21) Appl. No.: 19/076,453

(22) Filed: Mar. 11, 2025

(51) Int. Cl. E04B 1/18; F16B 2/20

(52) U.S. Cl. CPC E04B 1/185; F16B 2/20

(57) ABSTRACT

A framing system including a clip configured to couple with an identical opposing clip attached to a second tee. The clip and the identical opposing clip each having a body portion attached to an end of a respective tee. The body portion having an opening formed therein, and a nose portion extending from the body portion. The nose portion comprising a catch formed on one side thereof. When the clip is connected to the identical opposing clip, the nose portion of the clip extends through a pocket formed between the body portion of the identical opposing clip and the second tee into the opening formed in the body portion of the identical opposing clip and the catch of the clip engages a mating edge of the opening formed in the body portion of the identical opposing clip.

### BACKGROUND OF THE INVENTION

The invention relates to improvements in drywall steel framing and, in particular to framing non-wall areas, e.g., soffits, bulkheads, perimeters and facia.

### PRIOR ART

Typically, framing screws are used to secure drywall steel framing together. After the steel framing is secured together, drywall sheets may be attached to the steel framing. Non-wall areas, e.g., soffits, bulkheads, perimeters and facia, are typically complicated and require a higher level of skill by an installer. It is desirable that connectors be used to ease the assembly of the drywall steel framing and reduce the assembly time while not requiring highly-skilled installers.

### SUMMARY OF THE INVENTION

The invention provides a framing system having a tee having a web extending from a flange. A clip is configured to couple with an identical opposing clip attached to a second tee. Each clip includes a body portion attached to an end of a respective tee. The body portion has an opening formed therein. A nose portion extends from the body portion. The nose portion includes a catch formed on one side thereof. When the clip is connected to the identical opposing clip, the nose portion of the clip extends through a pocket formed between the body portion of the identical opposing clip and the second tee into the opening formed in the body portion of the identical opposing clip and the catch of the clip engages a mating edge of the opening formed in the body portion of the identical opposing clip. The nose portion of the identical opposing clip extends through a pocket formed between the body portion of the clip and the tee into the opening formed in the body portion of the clip and the catch of the identical opposing clip engages a mating edge of the opening formed in the body of the clip. Engagement of the catch of the clip with the mating edge of the opening of the identical opposing clip and the catch of the identical opposing clip with the mating edge of the opening of the clip secures the clip and the identical opposing clip together.

### BRIEF DESCRIPTION OF THE DRAWINGS

FIG. 1 is a side view of ends of tees and inventive clips spaced from each other;

FIG. 2 is a side view of the tees of FIG. 1 with the ends of the tees connected by the inventive clips;

FIG. 3A is a perspective view of the end of one of the tees of FIG. 1;

FIG. 3B is a cross-sectional view of the end of the tee taken in the plane 3B-3B of FIG. 3A;

FIG. 4A is a perspective view of the clip of FIG. 1;

FIG. 4B is a cross-sectional view of the clip taken in the plane 4B-4B of FIG. 4A;

FIG. 5A is a cross-sectional view of a clinching tool in a first position adjacent the clip and tee of FIG. 1 taken in the plane 5A-5A of FIG. 1;

FIG. 5B is a cross-sectional view of the clinching tool of FIG. 5A in a second position taken in the plane 5A-5A of FIG. 1, wherein the clip is clinched to the tee;

FIG. 6A is a cross-sectional view of the clips on the ends of the tees partially engaged with each other, taken in the plane 6-6 of FIG. 2;

FIG. 6B is a cross-sectional view taken in the plane 6-6 of FIG. 2;

FIG. 7 is a perspective view of FIG. 6B; and

FIG. 8 is a side view of an embodiment wherein the inventive clips of FIG. 1 are attached at an angle J to define an inside corner of a wall.

### DESCRIPTION OF THE PREFERRED EMBODIMENTS

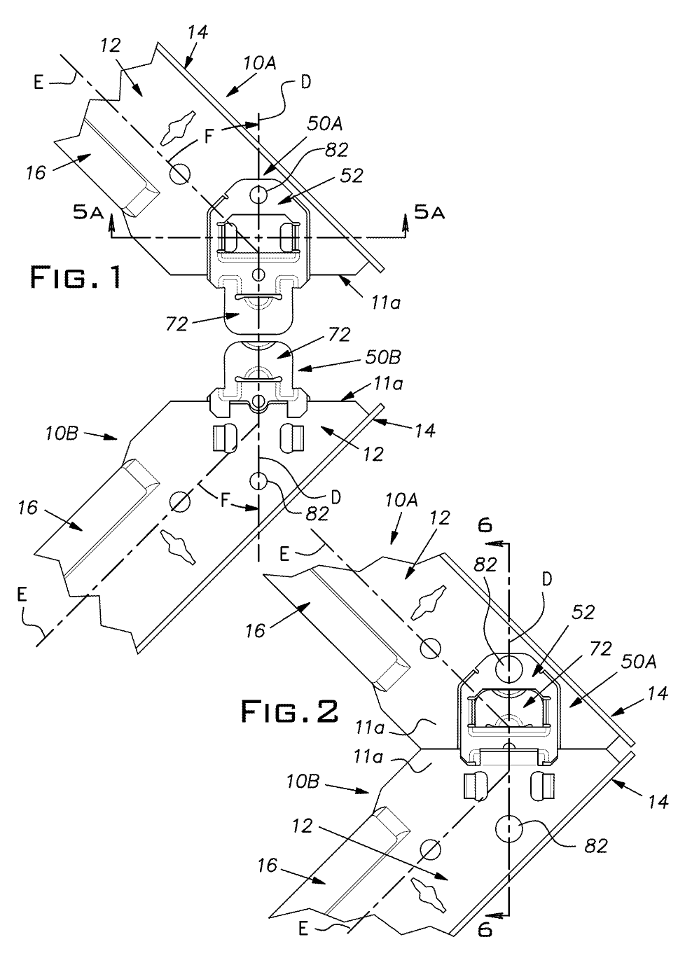

FIGS. 1 and 2 show end portions of a tee 10A and a second tee 10B, the full length of each tee 10A, 10B may be a length of a section of a wall desired to be framed. In the embodiment shown, the tees 10A, 10B form an outside corner of the wall at about 90 degrees. In the embodiment illustrated, an angle F is about 45 degrees so that when the tees 10A, 10B are connected they define the outside corner of the wall. The outside corner of the wall is formed by placing dry wall boards (not shown) on lower flanges 14 of the tees 10A, 10B. In other embodiments (not shown) the angle of the corner may be greater or less than 90 degrees. In yet other embodiments (see, FIG. 8), the tees 10A, 10B may form an inside corner of the wall at degrees equal to 90 degrees or greater than or less than 90 degrees. In the embodiment illustrated, an angle J is about 45 degrees so that when the tees 10A, 10B are connected they define the inside corner of the wall. The inside corner of the wall is formed by placing dry wall boards (not shown) on lower flanges 14 of the tees 10A, 10B.

At least one end 11a of the tee 10A includes a clip 50A and at least one end 11a of the second tee 10B includes an opposing clip 50B. The tees 10A, 10B and the clips 50A, 50B are identical and only the tee 10A and the clip 50A will be described in detail below, for brevity. The description of the tee 10A and the clip 50A applies equally to the second tee 10B and the opposing clip 50B. The reference numbers used for the tee 10A and the clip 50A apply equally to the second tee 10B and the opposing clip 50B.

The tee 10A preferably is made with light gauge hot dipped galvanized steel, having a thickness as low as, for example, 0.010 inch, has an inverted T-cross-section (in use) with a web 12 extending between the lower flange 14 and an upper reinforcing bulb 16. An end portion of the upper reinforcing bulb 16 of the tee 10A may be flattened to facilitate attachment of the clip 50A to the tee 10A, as described in detail below. It is also contemplated that the tee 10A may not include the upper reinforcing bulb 16 (see, e.g., FIGS. 5A and 5B).

The clip 50A may be formed from a web material and a body portion 52 of the clip 50A may be attached to the tee 10A between the lower flange 14 and the upper reinforcing bulb 16. Typically, as is conventional, the web 12 may be formed as a double layer of the sheet steel. For simplicity and visual clarity, the web 12 is sometimes shown as a single layer in the drawings.

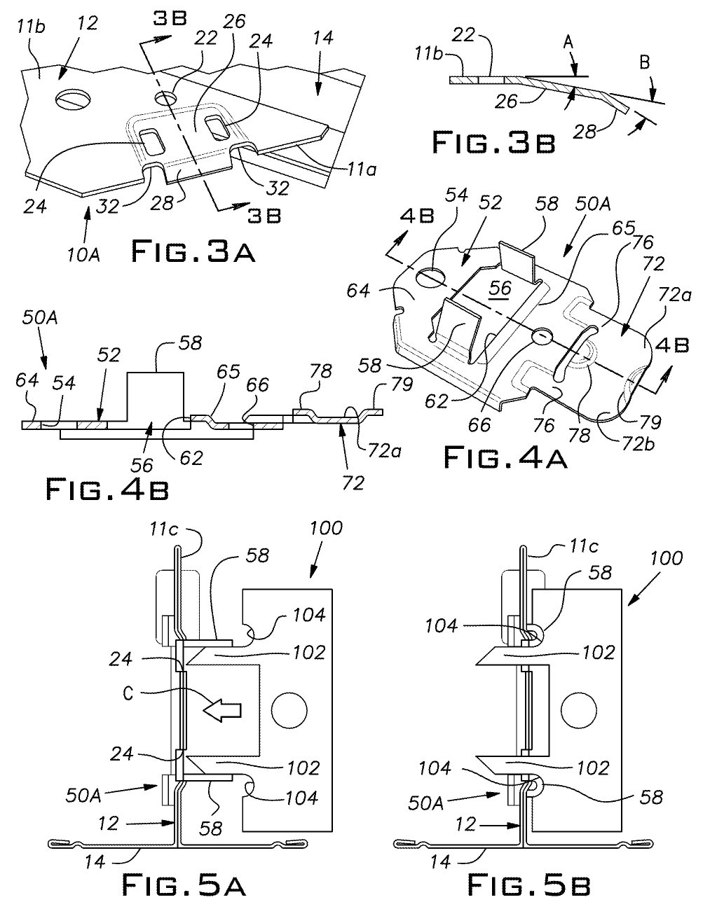

Referring to FIGS. 3A and 3B, the tee 10A includes a mounting hole 22 for securing the clip 50A to the tee 10A. A pair of spaced-apart holes 24 are provided for receiving a pair of mounting tabs 58 (FIGS. 4A and 4B) of the clip 50A, as described in detail below. The pair of spaced-apart holes 24 extend through a pocket surface 26 formed on the end 11a of the tee 10A. The pocket surface 26 slopes away from a surface 11b of the tee 10A toward the end 11a of the tee 10A. In the orientation illustrated in FIGS. 3A and 3B, the pocket surface 26 slopes down from the surface 11b of the tee 10A. The pocket surface 26 may be sloped at an angle A relative to the surface 11b. It is contemplated that angle A may be between about 3 degrees and about 25 degrees, preferably about 7 degrees. A pocket lead 28 is formed on a distal end of the pocket surface 26. The pocket lead 28 may be sloped at an angle B relative to the pocket surface 26. Angle B may be between about 10 degrees and about 35 degrees, preferably about 28 degrees. A pair of notches 32 may be formed in the distal end of the tee 10A on either side of the pocket surface 26 and the pocket lead 28 to facilitate the bending of the pocket surface 26 and the pocket lead 28 relative to the surface 11b of the tee 10A.

Referring to FIGS. 4A and 4B, the clip 50A includes the body portion 52 and a nose portion 72 that extends from one side of the body portion 52. A mounting hole 54 is formed in one end of the body portion 52 for receiving a fastener 82 (FIGS. 1 and 2) to fix the clip 50A to the tee 10A. An opening 56 is formed in the body portion 52 and is dimensioned and positioned as described in detail below. In the embodiment illustrated, the opening 56 is generally rectangular in shape. The pair of mounting tabs 58 extend from the body portion 52 from opposite edges of the opening 56.

A mating edge 62 of the opening 56, opposite the mounting hole 54, extends between the pair of mounting tabs 58 and is raised above a surrounding surface 64 of the body portion 52 of the clip 50A. In the embodiment illustrated, an entire length of the mating edge 62 is raised above the surrounding surface 64 of the body portion 52. A reinforcing rib 65 may be formed in the body portion 52 and extend parallel to the mating edge 62. The reinforcing rib 65 may be formed as raised elongated bump. A hole 66 may extend through the body portion 52 adjacent the mating edge 62. The hole 66 is positioned and dimensioned as described in detail below.

A pair of bridges 76 may connect the nose portion 72 to a side of the body portion 52 that is proximate the hole 66. The bridges 76 may be configured to allow the nose portion 72 to flex relative to the body portion 52, as described in detail below. A catch 78 is formed on an edge of the nose portion 72 that is adjacent the body portion 52. In the orientation illustrated in FIGS. 4A and 4B, the catch 78 is raised above a surface 72a of the nose portion 72. In the embodiment shown, the catch 78 is arcuate in shape. A nose lead 79 is formed on a lead end 72b of the nose portion 72. The nose lead 79 may be formed by raising a portion of the nose portion 72 above the surface 72a of the nose portion 72. In the embodiment shown, the nose lead 79 is arcuate in shape.

Referring back to FIGS. 1 and 2, the clip 50A is attached to the tee 10A by inserting the pair of mounting tabs 58 (FIGS. 4A and 4B) of the clip 50A through the spaced-apart holes 24 (FIG. 3A) of the tee 10A. The pair of mounting tabs 58 (FIGS. 4A and 4B) may be clinched to the tee 10A using a clinching tool 100 (FIG. 5A and 5B). As shown in FIGS. 5A and 5B, the clinching tool 100 includes two spaced-apart legs 102 and a curved recess 104 formed at a base of each leg 102. The clip 50A is secured to the tee 10A by inserting the mounting tabs 58 through the holes 24 of the tee 10A. The clip 50A is held against the tee 10A and the clinching tool 100 is positioned adjacent an opposite second surface 11c of the tee 10A. As the clinching tool 100 moves toward the tee 10A (in the direction of arrow C in FIG. 5A), the legs 102 of the clinching tool 100 extend into the holes 24. As the clinching tool 100 continues to move toward the tee 10A, the distal ends of the mounting tabs 58 engage the respective curved recess 104 of the clinching tool 100 and are curved back towards the second surface 11c of the tee 10A. The clinching tool 100 continues to move toward the second surface 11c until the tabs 58 are clinched against the second surface 11c of the tee 10A. It is contemplated that other tools (not shown) may be used to clinch the tabs 58 of the clip 50A to the tee 10A. Referring back to FIGS. 1 and 2, the fastener 82 may be inserted into the mounting hole 22 (FIG. 3A) of the tee 10A and the mounting hole 54 (FIG. 4A) of the clip 50A to secure the clip 50A to the tee 10A.

In the embodiment illustrated in FIGS. 1, 2 and 8, a longitudinal axis D of the clip 50A is positioned at the angle F relative to a longitudinal axis E of the tee 10A. It is contemplated that the angle F may be selected to provide the inside corner (FIG. 8) or outside corner (FIGS. 1 and 2) of the drywall frame at a desired angle, as described above. It is contemplated that the angle F may be between about -45 degrees and about 90 degrees. The clips 50A, 50B of the present invention may be selectively positioned on the tees 10A, 10B so that when the tees 10A, 10B are connected and dry wall boards (not shown) are placed on the lower flange 14 of each tee 10A, 10B, the assembly defines either the outside corner at about 270 degrees (see, FIG. 2), the inside corner at about 90 degrees (see, FIG. 8) or a corner (not shown) at any angle between the outside corner (FIG. 2) and the inside corner (FIG. 8). It also contemplated that the clips 50A, 50B may be selectively positioned on the tees 10A, 10B to define outside corners that are greater than 270 degrees or inside corners that are less than 90 degrees.

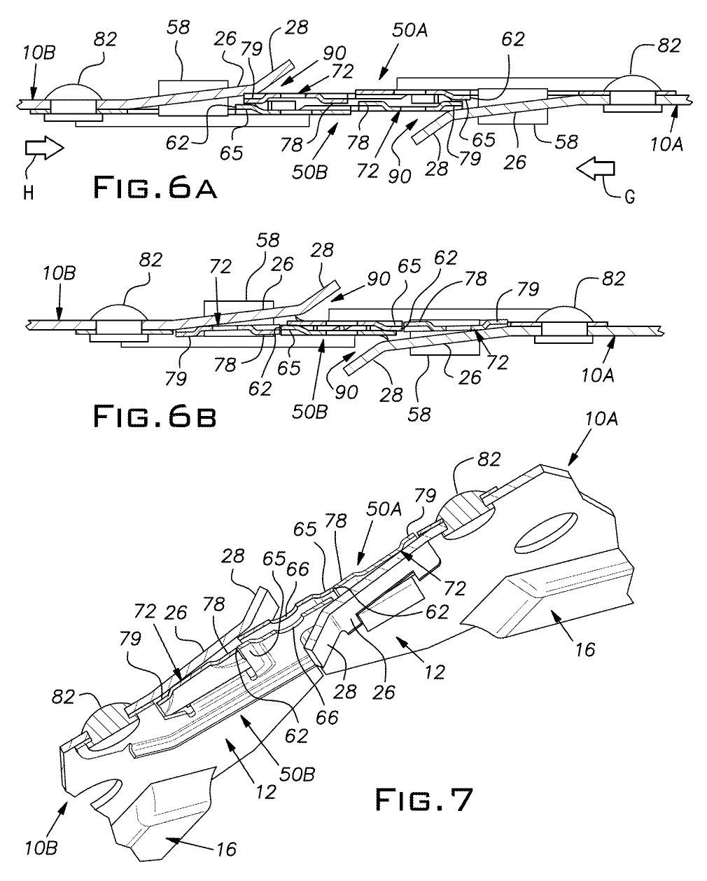

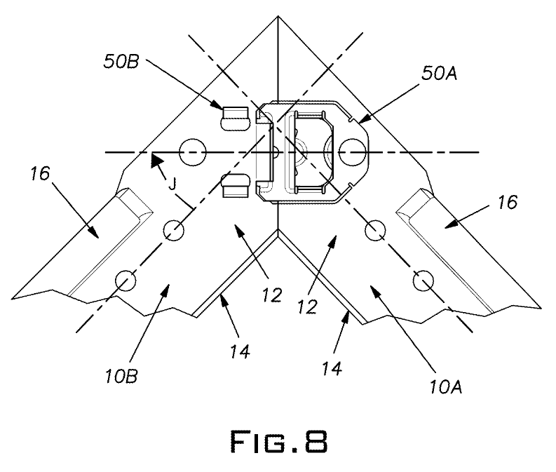

Referring to FIGS. 6A-7, when the clip 50A is attached to the tee 10A, the body portion 52 of the clip 50 and the pocket surface 26 of the tee 10A defines a pocket 90 for receiving the nose portion 72 of the opposing clip 50B. The clips 50A, 50B are connected by aligning the nose portion 72 of each clip 50A, 50B with the pocket 90 of the other of the clips 50A, 50B and moving the tee 10A (with clip 50A attached thereto) in the direction of arrow G and the second tee 10B (with the opposing clip 50B attached thereto) in the direction H (see, FIG. 6A). For clarity, the following description will be made with reference to inserting the nose portion 72 of the clip 50A into the pocket 90 formed between the opposing clip 50B and the second tee 10B. One skilled in the art appreciates that the both clips 50A, 50B are inserted into the pocket 90 of the other of the clips 50A, 50B, simultaneously.

Referring to the insertion of the clip 50A into the opposing clip 50B, the nose lead 79 of the clip 50A is configured to ease in the insertion of the nose portion 72 of the clip 50 into the pocket 90 of the opposing clip 50B. As the clip 50A moves toward the opposing clip 50B (in the direction of arrow G in FIG. 6A), the nose portion 72 of the clip 50A enters the pocket 90 between the opposing clip 50B and the second tee 10B. The nose portion 72 of the clip 50A is guided by the pocket lead 28 of the second tee 10B so that the nose lead 79 moves into the pocket 90 of the second tee 10B and into the opening 56 (FIG. 4A) of the opposing clip 50B, as illustrated in FIG. 6A. The pocket surface 26 of the second tee 10B is configured to bias the nose portion 72 of the clip 50A downward into the opening 56 (as viewed in the orientation illustrated in FIGS. 6A and 6B). The opening 56 of the opposing cling 50B is dimensioned to receive the nose portion 72 of the clip 50A.

Referring to FIGS. 6B and 7, once the catch 78 on the nose portion 72 of the clip 50A has passed the mating edge 62 of the opening 56 of the opposing clip 50B, the nose portion 72 of the clip 50A is forced into the opening 56 of the opposing clip 50B. It is contemplated that the sudden movement of the nose portion 72 may result in an audible “click” sound as the nose portion 72 snaps into the opening 56. It is contemplated that the nose portion 72 of the clip 50A and the opening 56 of the opposing clip 50B may be dimensioned and configured so that the sudden movement of the nose portion 72 may correspond to the nose lead 79 of the nose portion 72 of the clip 50A abutting a rear edge of the opening 56. The rear edge of the opening 56 may be configured to stop further movement of the clip 50A in the direction G. In this respect, the rear edge of the opening 56 may act as a stop for the clip 50A.

It is contemplated that the pocket surface 26 of the second tee 10B may be configured to resiliently hold the nose portion 72 of the clip 50A in the opening 56 of the opposing clip 50B. As illustrated in FIGS. 6B and 7, when the nose portion 72 is fully inserted into the opening 56 of the second tee 10B, the pocket surface 26 causes the nose portion 72 to be slightly offset relative to the body portion 52. The bridges 76 between the body portion 52 and the nose portion 72 of the clip 50A may be configured to allow the nose portion 72 to deflect relative to the body portion 52, thereby allowing the nose portion 72 to move into the opening 56 of the opposing clip 50B.

Referring to FIG. 7, when the clips 50A, 50B are fully connected, the holes 66 in the clips 50A, 50B align with each other. It is contemplated that a fastener (not shown), e.g., a bolt, may be placed into the holes 66 to improve the fastening of the clips 50A, 50B together.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A framing system comprising:
a tee having a web extending from a flange; and
a clip configured to couple with an identical opposing clip attached to a second tee, the clip and the identical opposing clip each comprising a body portion attached to an end of a respective tee, the body portion having an opening formed therein, and a nose portion extending from the body portion, the nose portion comprising a catch formed on one side thereof,
wherein, when the clip is connected to the identical opposing clip, the nose portion of the clip extends through a pocket formed between the body portion of the identical opposing clip and the second tee into the opening formed in the body portion of the identical opposing clip and the catch of the clip engages a mating edge of the opening formed in the body portion of the identical opposing clip, and the nose portion of the identical opposing clip extends through a pocket formed between the body portion of the clip and the tee into the opening formed in the body portion of the clip and the catch of the identical opposing clip engages a mating edge of the opening formed in the body portion of the clip,
wherein engagement of the catch of the clip with the mating edge of the opening of the identical opposing clip and the catch of the identical opposing clip with the mating edge of the opening of the clip secures the clip and the identical opposing clip together.

2. The framing system as set forth in claim 1, wherein the tee biases the nose portion of the identical opposing clip into the opening in the body portion of the clip and the second tee biases the nose portion of the clip into the opening in the body portion of the identical opposing clip.

3. The framing system as set forth in claim 2, wherein the clip is biased by a pocket surface of the second tee and the identical opposing clip is biased by a pocket surface of the tee.

4. The framing system as set forth in claim 1, wherein the clip is angled relative to a longitudinal axis of the tee and the identical opposing clip is angled relative to a longitudinal axis of the second tee.

5. The framing system as set forth in claim 1, wherein a pair of bridges connect the nose portion of the clip or the identical opposing clip to the body portion of the clip or the identical opposing clip, respectively.

6. The framing system as set forth in claim 1, wherein the clip and the identical opposing clip each include a hole that aligns with each other when the clip and the identical opposing clip are connected to each other.

7. The framing system as set forth in claim 1, wherein the clip is angled relative to a longitudinal axis of the tee and the identical opposing clip is angled relative to a longitudinal axis of the second tee to define an outside corner or an inside corner of a wall when the clip is connected to the identical opposing clip.
